(19) United States
(12) Patent Application Publication
(10) Pub. No.: US 2012/0174356 A1
(43) Pub. Date: Jul. 12, 2012

(54) ECOLOGICALLY FRIENDLY, FURNITURE QUALITY CASKET

(76) Inventors: Bradley S. Laking, Luna Pier, MI (US); Tim Sprulock, Carey, OH (US); Connie Spurlock, Carey, OH (US); Kenneth Fox, Monroe, MI (US); Michael Levy, Maumee, OH (US); Bruce Burnside, Spring Lake, MI (US)

(21) Appl. No.: 13/210,760

(22) Filed: Aug. 16, 2011

Related U.S. Application Data
(60) Provisional application No. 61/401,635, filed on Aug. 16, 2010.

(51) Int. Cl. A61G 17/02; A61G 17/04

(52) U.S. Cl. 27/12; 27/16

(57) ABSTRACT

A casket is provided that is made entirely from ecologically friendly materials, yet still provides a furniture quality appearance. The casket includes a box having a bottom, a front wall, a rear wall, and a pair of end walls. A lid is pivotally supported relative to the box by a hinge assembly for movement between a closed position and an opened position. The casket also includes a locking mechanism that is operable to secure the lid in the closed position. The box, the lid, the hinge assembly, and the locking mechanism are made entirely from naturally occurring materials.

### CROSS-REFERENCE TO RELATED APPLICATIONS

This application claims the benefit of U.S. Provisional Application No. 61/401,635 filed Aug. 16, 2010, the disclosure of which is incorporated herein by reference.

### BACKGROUND OF THE INVENTION

This invention relates in general to caskets, such as can be used in the display and burial of a body. In particular, this invention relates to an improved structure for a casket that is made entirely from ecologically friendly materials, yet still provides a furniture quality appearance.

Caskets are well known structures that are used in the display and burial of a body. A typical casket defines a box-like structure that includes a bottom, a front wall, a rear wall, two end walls, and at least one lid pivotally supported thereon for movement between an opened position and a closed position. Caskets are generally made from a wide variety of materials, including wood, plastic, fiberglass, metal, and other materials. However, a majority of these materials are not ecologically friendly and, in some instances, can be harmful for the environment when disposed in the ground for extended periods of time. Thus, it would be desirable to provide a casket that is made entirely from ecologically friendly materials, yet still provides a furniture quality appearance.

### SUMMARY OF THE INVENTION

This invention relates to an improved structure for a casket that is made entirely from ecologically friendly materials, yet still provides a furniture quality appearance. The casket includes a box having a bottom, a front wall, a rear wall, and a pair of end walls. A lid is pivotally supported relative to the box by a hinge assembly for movement between a closed position and an opened position. The casket also includes a locking mechanism that is operable to secure the lid in the closed position. The box, the lid, the hinge assembly, and the locking mechanism are made entirely from naturally occurring materials.

Various aspects of this invention will become apparent to those skilled in the art from the following detailed description of the preferred embodiment, when read in light of the accompanying drawings.

### BRIEF DESCRIPTION OF THE DRAWINGS

FIG. 1 is a perspective view of a casket having a lid in an opened position in accordance with this invention.

FIG. 2 is an enlarged sectional side view of a portion of the casket shown in FIG. 1 illustrating a hinge assembly when the lid is in a closed position.

FIG. 3 is a sectional side view similar to FIG. 2 illustrating the hinge assembly when the lid is in the opened position.

FIG. 4 is a perspective view of the casket shown in FIG. 1 illustrating a locking mechanism in the locked position.

FIG. 5 is a front elevational view of the locking mechanism shown in FIG. 4 with a decorative cover removed.

FIG. 6 is a sectional view of an internal portion of the casket shown in FIG. 4 illustrating the locking mechanism in a locked position.

FIG. 7 is a sectional view of an internal portion of the casket shown in FIG. 4 illustrating the locking mechanism being rotated from the locked position to an unlocked position.

FIG. 8 is a sectional side view of a casket having an alternative locking mechanism, in accordance with this invention.

FIG. 9 is a perspective view of an adjustable bed for use in the casket shown in FIG. 1.

FIG. 10 is a perspective view of an internal portion of the casket shown in FIG. 1 illustrating a bed pillow system being inserted into a groove that is provided in a cap of the casket.

FIG. 11 is a cross sectional side view of the bed pillow system inserted into the groove of the cap as shown in FIG. 10.

### DETAILED DESCRIPTION OF THE PREFERRED EMBODIMENT

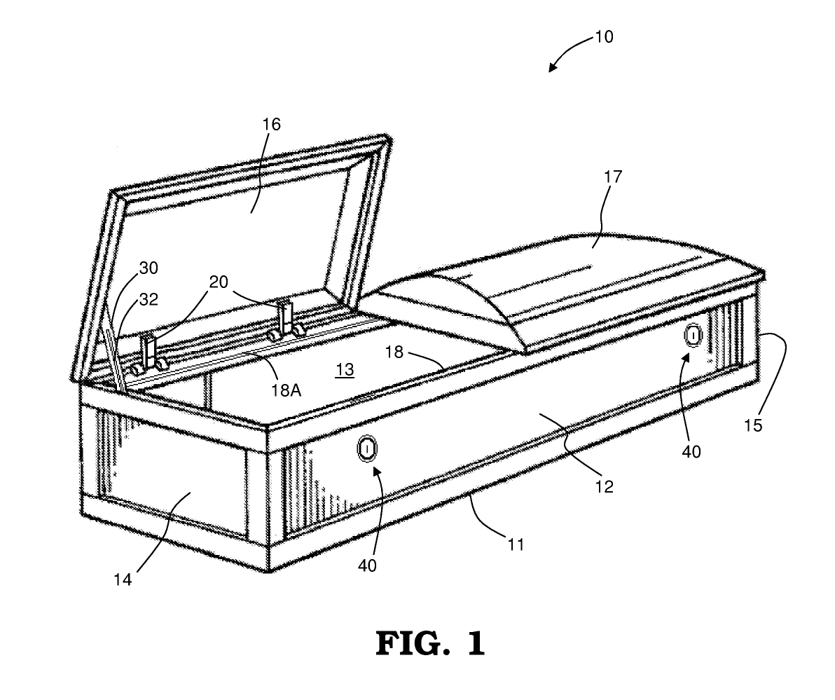

Referring now to the drawings, there is illustrated in FIG. 1 a casket, indicated generally at 10, in accordance with this invention. The casket 10 can be used in the display and burial of a body (not shown). As will be explained below, the casket 10 is made entirely from natural occurring materials that are ecologically friendly and safe for the environment. Although the casket 10 will be described for use in the display and burial of a body, it should be appreciated that the casket 10 can be otherwise used in any desired environment and for any desired purposed.

The illustrated casket 10 defines a box-like structure that includes a bottom 11, a front wall 12, and rear wall 13, and end walls 14 and 15. In other non-illustrated embodiments, the casket 10 can have any number or configuration of walls (i.e. a six sided coffin, for example). The casket 10 may also include any number of lids, such as a pair of lids 16 and 17, which are pivotally supported on the rear wall 13, as shown. The lids 16 and 17 are pivotal between an opened position for display of a body and a closed position for burial of the body. The lids 16 and 17 can be any shape or have any structural features for a desired application.

The illustrated casket also includes a cap 18 that is secured along upper edges of the respective walls 12, 13, 14, and 15, although such is not required. As shown, the cap 18 is configured to extend around a perimeter of the casket 10 that is defined by the walls 12, 13, 14, and 15. The illustrated cap 18 defines a T-shape configuration with the walls 12, 13, 14, and 15. The cap 18 adds structural strength to the casket 10 for reducing or minimizing deflection and bowing thereof. As such, the cap 18 can have any dimensions based on the strength required due to various wood densities and expected weight loads. The cap 18 also provides a flat, stable base for the lids 16 and 17 to be seated onto the walls 12, 13, 14, and 15. The cap 18 also adds depth to the appearance of the walls 12, 13, 14, and 15 and allows movable components of the casket 10 to be concealed from view, as will be further explained below.

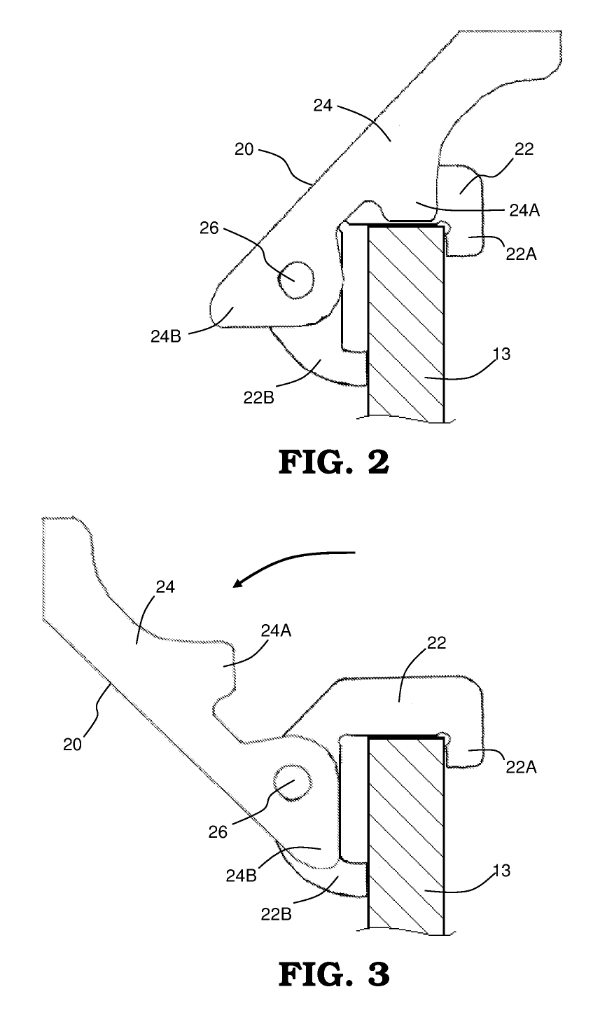

The illustrated casket 10 also includes a plurality of hinge assemblies 20 that pivotally support the lids 16 and 17 to the rear wall 13. The hinge assemblies 20 are similar and, therefore, only one hinge assembly 20 will be further described with reference to FIGS. 2 and 3. The illustrated hinge assembly 20 is pivotal between a first or closed position, as shown in FIG. 2, and a second or opened position, as shown in FIG. 3. It should be appreciated, however, that the hinge assembly 20 can pivotally support the lids 16 and 17 in any desired position.

The hinge assembly 20 includes at least one base member 22 that is secured to the rear wall 13 of the casket 10. The hinge assembly 20 further includes a pivotal member 24 that is secured to the lid 16 (not shown). The pivotal member 24 is pivotally mounted to the base member 22 by a dowel pin 26 or the like to facilitate pivotal movement of the lid 16 relative to the casket 10. In the illustrated embodiment shown in FIG. 1, the pivotal member 24 is secured between a pair of the base members 22. However, it should be appreciated that the hinge assembly 20 can be configured in any manner.

As shown in FIGS. 2 and 3, the base member 22 includes a front leg 22A and a rear leg 22B that straddle the rear wall 13 for firmly supporting the base member 22 thereto. For example, the front leg 22A extends downwardly along an inner surface of the rear wall 13 and includes a surface that is configured to be seated against the inner surface of the rear wall 13. Similarly, the rear leg 22B extends downwardly along an outer surface of the rear wall 13 and includes a surface that is configured to be seated against the outer surface of the rear wall 13. As such, the base member 22 can be mounted over the cap 18 if so desired. The base member 22 can be secured to the rear wall 13 in any manner, including but not limited to a natural adhesive, wooden dowels, a tongue-and-groove connection, or any other means.

The illustrated pivotal member 24 is an elongated arm that radially extends outwardly from the base member 22. The pivotal arm 24 is configured to be attached to the lid 16 to facilitate pivotal movement thereof between the open and closed positions. The pivotal arm 24 can be attached to the lid 16 in any manner, including but not limited to a natural adhesive, wooden dowels, a tongue-and-groove connection, or any other means.

The illustrated pivotal member 24 also includes a first shoulder 24A, although such is not required. The first shoulder 24A is configured to engage the upper edge of the rear wall 13 or the cap 18 when the lid 16 is in the fully closed position to prevent further pivotal movement. As shown, the first shoulder 24A extends outwardly from an inner surface of the pivotal member 24 and is centrally located along a length thereof. The first shoulder 24A can be integrally formed with the pivotal member 24 or can be a separate component that is secured thereto if so desired.

The illustrated pivotal member 24 also includes a second shoulder 24B, although such is not required. The second shoulder 24B is configured to engage an outer surface of the rear wall 13 or any other portion of the casket 10 when the lid 16 is in the fully opened position to prevent further pivotal movement. As shown, the second shoulder 24B extends from an end portion of the pivotal member 24B that is connected to the base member 22. It should be appreciated that the second shoulder 24B can be have any size or shape to allow the lid 16 to achieve a desired opened position. The second shoulder 24B can be integrally formed with the pivotal member 24 or can be a separate component that is secured thereto if so desired.

As briefly mentioned above, the dowel pin 26 pivotally attaches the pivotal member 24 to the base member 22. The dowel pin 26 can be a wooden, rod-like member that is disposed within aligned apertures formed in each of the base member 22 and the pivotal member 24. The illustrated dowel pin 26 defines an axis that is spaced from an outer surface of the rear wall 13 and spaced a distance below a top edge of the rear wall 13, thereby allowing the lid 16 to fully pivot away from the rear wall 13 and achieve a fully opened position. It should be appreciated that the dimensions of the hinge assembly 20 and its various components can be modified to accommodate heavier or lighter load expectations and wood types.

Referring back to FIG. 1, a support arm 30 is connected to at least one of the lids 16 and 17 by a dowel pin (not shown) for supporting the respective lid 16 and 17 in the opened position, although such is not required. The illustrated support arm 30 is an elongated member that extends downwardly from an inner surface of the lid 16 and through a slot (not shown) formed in an upper surface of the cap 18. Thus, the support arm 30 is largely concealed within the interior of the casket 10 and is fitted through the cap 18 for added structural strength and provides smooth, uninterrupted movement as the lid 16 is pivoted between the open and closed positions.

The illustrated support arm 30 defines a slot 32 that may extend along any length thereof. The slot 32 is configured to receive a guide (not shown) that is fixed to the inner surface of the end wall 14. The slot 32 provides a generally linear path that includes an L-shaped end portion (not shown) near a free end of the support arm 30. As the lid 16 is pivoted between the open and closed positions, the support arm 30 moves relative to the guide, which travels along the slot 32. When the lid 16 reaches the fully opened position, the free end of the support arm 30 automatically pivots downwardly such that the guide becomes engaged within the L-shaped end portion of the slot 32. This allows the lid 16 to be supported in the fully opened position. It should be appreciated that the support arm 30 and the slot 32 can have any size or shape, or may be otherwise configured for a desired application.

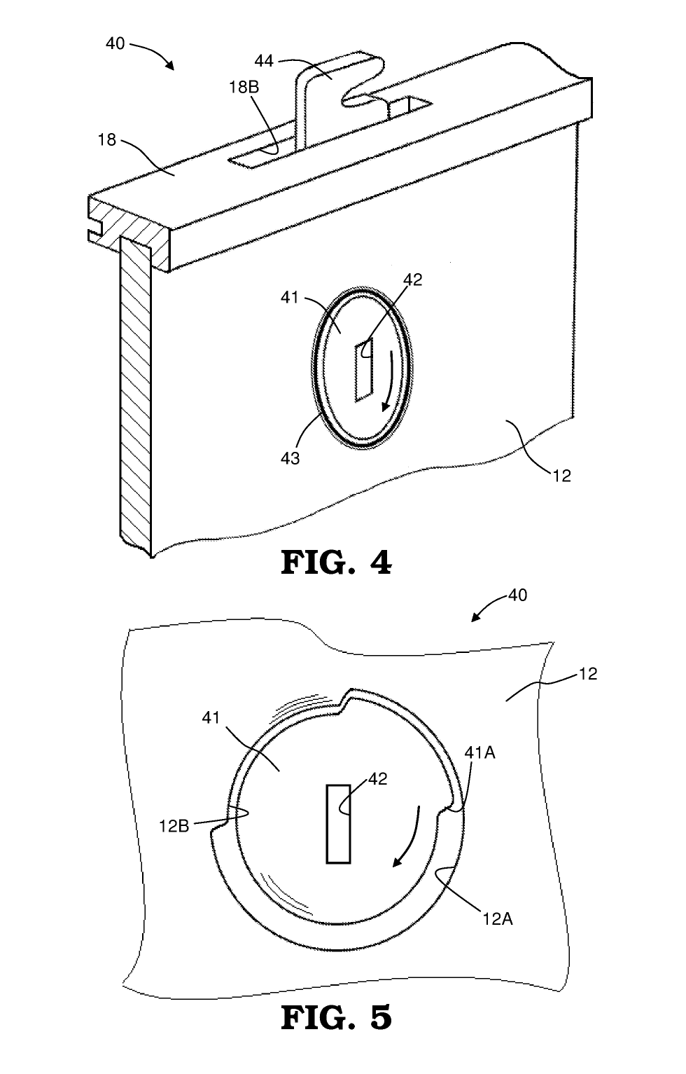

The illustrated casket 10 further includes a pair of locking mechanisms, indicated generally at 40, for respectively locking the lids 16 and 17 in the closed position, although such is not required. The pair of locking mechanisms 40 are similar to one another and, therefore, only one of the locking mechanisms 40 will be described with reference to FIGS. 4 through 7. As shown in FIG. 4, the locking mechanism 40 includes a rotatable member 41 that is supported for rotation relative to the front wall 12. The rotatable member 41 can define a key-hole 42 formed therein. A decorative trim piece 43 can be secured to an outer surface of the front wall 12 to conceal edges of the rotatable member 41 if so desired. A latch member 44 is pivotally connected at its first end (not shown) to the rotatable member 41 and extends along an inner surface of the front wall 12 upwardly through a slot 18B formed in the cap 18, as will be further explained below. The locking mechanism 40 may, however, be supported relative to the rear wall 13 or the end walls 14 and 15 if so desired.

As shown in FIG. 5, a front elevational view of the locking mechanism 40 is illustrated with the trim piece 43 removed. The illustrated front wall 12 includes an aperture 12A that extends therethrough. The front wall 12 may also define a ledge or shoulder 12B that radially extends inwardly toward the aperture 12A, the purpose of which will be explained below. The rotatable member 41 is disposed within the aperture 12A of the front wall 12. The illustrated rotatable member 41 is annular in shape and may include a shoulder 41A that radially extends outwardly therefrom. The shoulder 12B of the front wall 12 and the shoulder 41A of the rotatable member 40 are configured to limit rotation movement of the rotatable member 41, such as approximately 180 degrees for example.

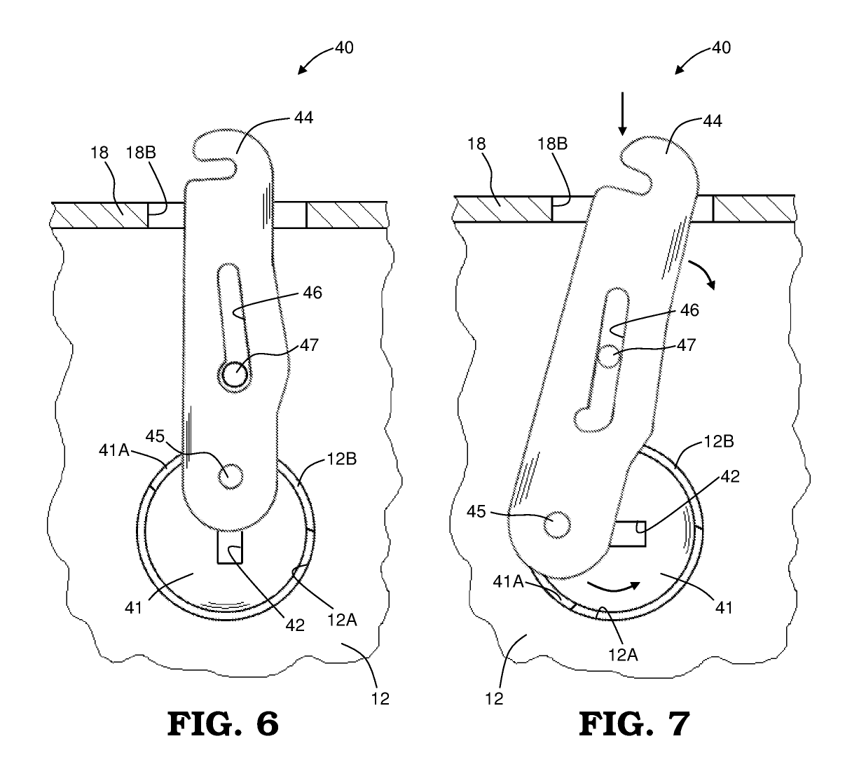

As shown in FIGS. 6 and 7, the illustrated latch member 44 is an elongated arm that is pivotally attached at a first end to the rotatable member 41. For example, the latch member 44 can be attached to the rotatable member 41 by a dowel pin 45 or the like. A second end of the latch member 44 defines a hook portion that is configured to secure the lid 16 (not shown) in the closed position.

The latch member 44 also includes a slot 46 that may extend along any length thereof. The slot 46 is configured to receive a guide pin 47 that is fixed to the front wall 12. For example, the guide pin 47 can be a wooden dowel pin having any dimensions. The slot 46 provides a generally linear path that includes an L-shaped end portion near the first end of the latch member 44. As the rotatable member 41 is rotated, the latch member 44 moves relative to the guide pin 47 via the slot 46. Thus, the guide pin 47 is configured to control pivotal movement of the latch member 44.

When the locking mechanism 40 is in a first or locked position, as shown in FIG. 6, the latch member 44 extends upwardly through the slot 18B formed in the cap 18 for engagement with the lid 16 (not shown). When the locking mechanism 40 is rotated to a second or unlocked position, as shown in FIG. 7, the second end of the latch member 44 is pivoted and disengages from the lid 16. The latch member 44 is then retracted downwardly through the slot 18B in the cap 18 and is concealed within an interior region of the casket 10. The illustrated locking mechanism 40 need not be lubricated if desired, thereby eliminating or reducing the potential for stain contamination of interior liners or mating components.

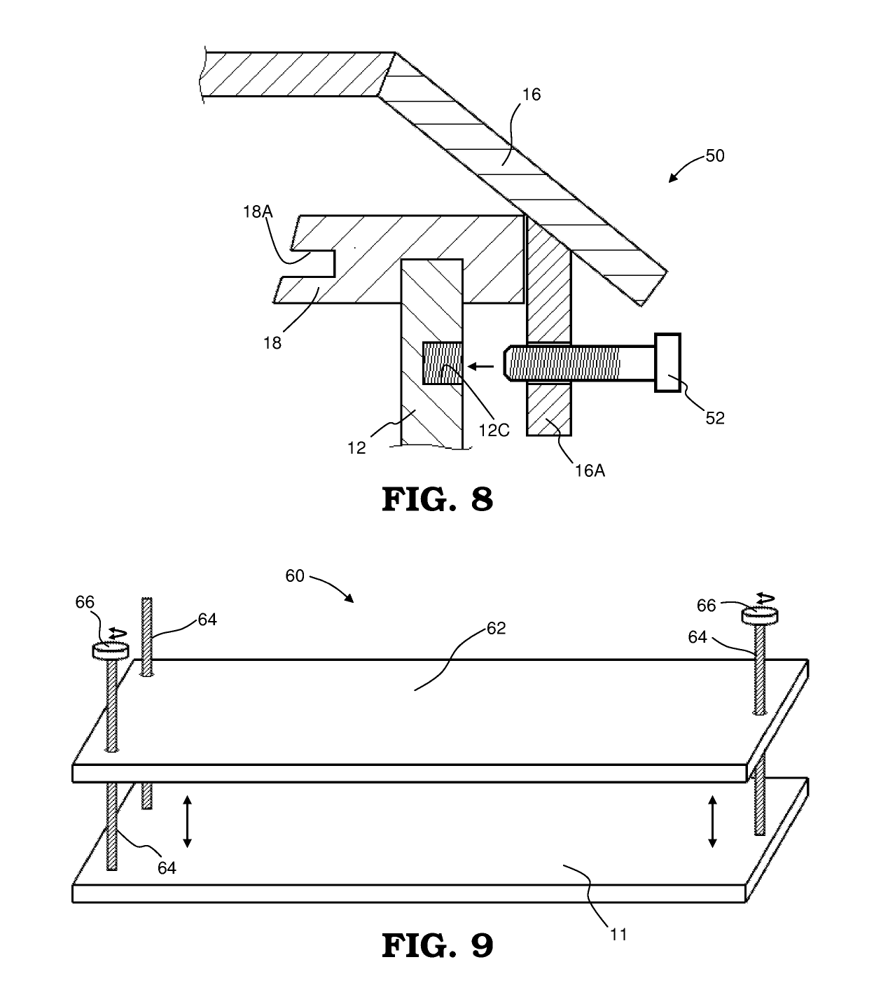

As shown in FIG. 8, there is illustrated an alternative embodiment of a locking mechanism, indicated generally at 50. The alternative locking mechanism 50 includes a locking pin 52 that extends through a portion of the lid 16 for engagement with the front wall 12. For example, the lid 16 may include a bracket 16A that extends downwardly therefrom along the front surface of the front wall 12. The illustrated bracket 16A includes an aperture extending therethrough. The locking pin 52 can be inserted through the aperture in the bracket 16A for engagement with the front wall 12.

As shown, the front wall 12 may include a recess 12C that extends into the front surface thereof. Thus, an end portion of the locking pin 52 can be received within the recess 12C to provide additional support. Alternatively, the locking pin 52 need not be received within a recess, but may otherwise be seated against or engage a lower surface of the cap 18. As shown, the locking pin 52 may be embodied as an externally threaded member, such as a threaded wooden dowel pin for example. In addition, the aperture in the bracket 16A and/or the recess 12C in the front wall 12 may have a corresponding internally threaded portion if so desired. It should be appreciated that the locking mechanism 50 can be configured in any other suitable manner.

Referring now to FIG. 9, there is illustrated an adjustable bed, indicated generally at 60, that can be disposed within an internal portion of the casket 10. The adjustable bed 60 enables a body to be selectively positioned at a desired elevation relative to the bottom 11 of the casket 10. The illustrated adjustable bed 60 includes a generally flat, rectangular bed plate 62 having a plurality of legs 64 vertically extending therethrough. The legs 64 can be wooden members having an externally threaded portion, such as threaded wooden dowels for example. The legs 64 are supported on the bottom 11 of the casket 10 and extend upwardly through internally threaded apertures in the bed plate 62. As such, the legs 64 form threaded connections with the apertures in the bed plate 62. A cap 66 or the like can be removably attached to an upper end of the legs 64 to facilitate rotation of the respective leg by hand. When the legs 64 are rotated, the bed plate 62 axially moves relative to the legs 64. Thus, the bed plate 62 can be raised or lowered to a desired height relative to the bottom 11 of the casket 10 if so desired.

As shown, a pair of the legs 64 is respectively located near opposite corners of a first end of the bed plate 62 for supporting the upper region of a body. A single leg 64 can be centrally located near a second end of the bed plate 62 for supporting the lower region of a body. It should be appreciated, however, that any number or configuration of legs 64 can be used depending on expected load weights and differing wood types.

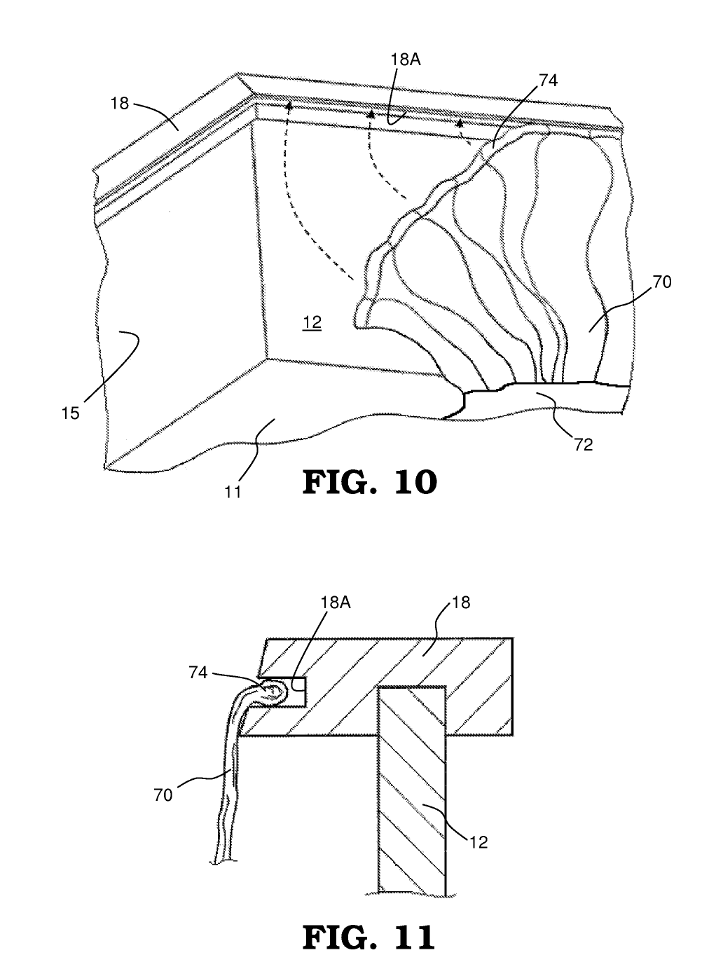

Referring now to FIGS. 10 and 11, the illustrated casket 10 is also provided with a bed pillow system that may include a skirt 70 and a bed pillow 72, although such is not required. The skirt 70 vertically extends along the inner surfaces of the walls 12, 13, 14, and 15, or any combination thereof. The skirt 70 can be made from any natural fabric that is ecologically friendly, such as cotton or silk for example.

The illustrated bed pillow 72 lies along an inner surface of the bottom 11. The bed pillow 72 can be made from wood shavings to achieve an absorbent, soft bed without the use of plastic or synthetic liners. For example, the bed pillow 72 can have a first layer of cotton, a second layer of wood shavings, a third layer of cotton, and fourth layer of wood shavings or wool, and a fifth layer of cotton. The layers can be sewn together to form the bed pillow 72 with a top sheet of silk. The bed pillow 72 may, however, be otherwise configured or formed from any other natural materials as desired. It should be appreciated that the skirt 70 and the bed pillow 72 can be sewn together to form a single bed pillow system or may be used separately.

To secure the illustrated skirt 70 and bed pillow 72 within the casket 10, the inner surfaces of the cap 18 may include a groove 18A that extends around the inner perimeter of the casket 10. Further, an upper edge of the skirt 70 may be provided with a cord 74. The cord 74 can be tucked into the groove 18A such that the skirt 70 hangs downwardly from the cap 18. The cord 74 can be any natural material that is ecologically friendly, such as twine, yarn, or the like. Thus, the groove 18A allows the skirt 70 to be attached along an inner perimeter of the casket 10 without the use of fasteners. The fastening system described herein also allows for easy installation and removal of the skirt 70 and/or the bed pillow 72 should they get soiled, torn, or otherwise need to be partially removed to add hidden pillows (not shown). The groove 18A may have any dimensions for use with a desired skirt 70 and may include a lip (not shown) or other structural features to help retain the cord 74 therein. Further, the groove 18A need not be formed in the cap 18, but may otherwise be provided along the inner surfaces of the respective walls 12, 13, 14 and 15 if so desired.

It should be appreciated that the casket 10 may include any additional features, such as structural or aesthetic features. For example, the casket 10 can include hand rails, internal corner posts, external end posts, fittings, decorative trimming, drapery, or the like. Further, all of the structural features of the casket 10 (i.e. walls, lids, hinges, locking mechanisms, pins, dowels, supports, etc.) can be made from naturally occurring materials, including but not limited to various woods such as pine, oak, yew, mahogany, bamboo, willow, hard woods, or any other ecologically friendly materials.

The principle and mode of operation of this invention have been explained and illustrated in its preferred embodiment. However, it must be understood that this invention may be practiced otherwise than as specifically explained and illustrated without departing from its spirit or scope.

What is claimed is:

1. A casket comprising:
a box having a bottom, a front wall, a rear wall, and a pair of end walls;
a lid;
a hinge assembly that pivotally supports the lid relative to the box for movement between a closed position and an opened position; and
a locking mechanism that is operable to secure the lid in the closed position;
wherein the box, the lid, the hinge assembly, and the locking mechanism are made from naturally occurring materials.

2. The casket of claim 1, wherein the hinge assembly includes a base member and a pivotal member that is pivotally mounted to the base member by a dowel pin.

3. The casket of claim 2, wherein the base member is secured to an upper edge of the box and includes a front leg that extends along an inner surface of the box and a rear leg that extends along an outer surface of the box.

4. The casket of claim 3, wherein the front leg of the base member is seated against the inner surface of the box and the rear leg of the base member is seated against the outer surface of the box.

5. The casket of claim 2, wherein the pivotal member includes a first shoulder that contacts an upper edge of the box when the lid is in the closed position.

6. The casket of claim 2, wherein the pivotal member includes a second shoulder that contacts an outer surface of the box when the lid is in the opened position.

7. The casket of claim 2, wherein the dowel pin defines an axis that is spaced from an outer surface of the box and also spaced a distance below an upper edge of the box.

8. The casket of claim 1, wherein the locking mechanism includes a rotatable member that is supported relative to the box, a latch member that is pivotally connected to the rotatable member, and a guide pin that is fixed to the box for engagement with the latch member.

9. The casket of claim 8, wherein the rotatable member is supported within an aperture that is formed in any one of the front, rear, and end walls of the box.

10. The casket of claim 8, wherein the rotatable member includes a shoulder that extends outwardly therefrom, the shoulder being configured to contact a portion of the box to limit rotation of the rotatable member.

11. The casket of claim 8 further including a cap that is secured along an upper edge of the box, wherein the latch member extends upwardly along an inner surface of the box and through a slot that is formed in the cap.

12. The casket of claim 8, wherein the latch member defines a slot that extends along a length thereof and the guide pin is received within the slot.

13. The casket of claim 8, wherein the latch member is retracted within an internal region of the box when the locking mechanism is in an unlocked position.

14. The casket of claim 1, wherein the locking mechanism includes a locking pin that extends through an aperture provided in the lid and contacts a portion of the box.

15. The casket of claim 1 further including an adjustable bed, wherein the adjustable bed has a bed plate and a plurality of legs that adjustably support the bed plate a height from the bottom of the box.

16. The casket of claim 15, wherein the legs extend through apertures in the bed plate and the legs form threaded connections with the apertures.

17. The casket of claim 1 further including a cap that extends along upper edges of the box, wherein the cap includes a groove that is configured to receive and secure a portion of a bed skirt therein.
